(19) United States
(12) Patent Application Publication
(10) Pub. No.: US 2011/0179013 A1
(43) Pub. Date: Jul. 21, 2011

(54) Search Log Online Analytic Processing

(75) Inventors: Daxin Jiang, Beijing (CN); Hang Li, Beijing (CN)

(73) Assignee: Microsoft Corporation, Redmond, WA (US)

(21) Appl. No.: 12/691,109

(22) Filed: Jan. 21, 2010

(51) Int. Cl. G06F 17/30

(52) U.S. Cl. 707/711; 707/706; 707/E17.108; 707/E17.032; 707/797

(57) ABSTRACT

A suffix-tree index may be constructed from search engine search logs. This suffix-tree is scalable and suitable for use in a distributed computing environment. Data mining against the data may proceed with functions including a forward search, backward search, and/or query session retrieval.

### BACKGROUND

Search logs, which record the search behavior of search engine users, contain rich and current information about users' needs and preferences. While search engines retrieve information from the Web, users implicitly vote for or against the retrieved information using their clicks. These search logs contain crowd intelligence accumulated from large numbers of users, which may be leveraged in social computing, customer relationship management, and many other areas.

Traditionally, search log tools have been highly customized and have not scaled well to the very large search logs which result from the current level of search activity. Thus, while a wealth of information is available in existing search logs, there have not been tools available to perform meaningful analysis of the information.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Described herein is an architecture and techniques of a search log online analytic processing (“OLAP”) system. Such a system is scalable and incorporates a distributed index of search logs such that patterns in search logs can be mined online. The mining may be performed to support search engines in responding to user queries as well as aiding search engine developers in their analysis and work.

Mining of the search log data may be done using one or more functions including forward search, query session retrieval, backward search, or combinations of these functions. A forward search function finds sequences which are consecutive to a query sequence in a session. Thus, a forward search returns the top-k most frequent sequences that have a specific prefix. Forward searches may be used to provide query suggestions based on user inputs.

A query session retrieval function finds the top-k query sessions that contain a specific sequence. Query session retrieval may be used to monitor search quality and diagnose causes of user dissatisfaction with query responses.

A backward search function, in contrast to a forward search function, finds the top-k most frequent sequences that have a specific suffix. Backward search may be used in a keyword bidding scenario, to help a keyword buyer locate terms which carry similar search intent, but perhaps are less expensive to bid on.

To support the OLAP using these three functions, a scalable distributed index structure may be used. This structure involves the use of one or more suffix tree indices distributed across a plurality of computing devices. By distributing indices across the plurality of computing devices, the functions may be performed online, with results presented in a timely manner to users and developers. Construction and maintenance of the trees comprising the indices may be accomplished with a MapReduce programming model.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1 is an illustrative architecture for search log OLAP configured to use forward search, backward search, and query session retrieval functions.

FIG. 2 is a table depicting an example set of query sessions and their associated query sequences.

FIG. 3 illustrates a suffix tree based on the table of FIG. 2.

FIG. 4 is a flow diagram of an example process of a forward search function executed against the suffix tree of FIG. 3.

FIG. 5 illustrates an enhanced suffix tree based on the table of FIG. 2.

FIG. 6 is a flow diagram of an example process of a query session retrieval function executed against the suffix tree of FIG. 5.

FIG. 7 illustrates a reversed suffix tree based on the table of FIG. 2.

FIG. 8 is a flow diagram of an example process of a backward search function executed against the reversed suffix tree of FIG. 7.

FIG. 9 illustrates the construction of a distributed index suitable for the forward search, backward search, and query session retrieval functions.

FIG. 10 is a flow diagram of an example process of building distributed index trees.

FIG. 11 illustrates the maintenance of the distributed index of FIG. 9.

FIG. 12 is a flow diagram of an example process of maintaining the distributed index trees.

### DETAILED DESCRIPTION

Described in this application are an architecture and techniques of a search log online analytic processing (“OLAP”) system. This system comprises a distributed index of a search log configured to enable a set of search functions, which may include a forward search, backward search, and query session retrieval. Such a system may be used in a search engine or with applications which rely on search engine-like functionality, such as genetic analysis.

This brief introduction is provided for the reader's convenience and is not intended to limit the scope of the claims, nor the following sections. Furthermore, the techniques described in detail below may be implemented in a number of ways and in a number of contexts. One example implementation and context is provided with reference to the following figures, as described below in more detail. However, it is to be appreciated that this following implementation and context is but one of many possible implementations.

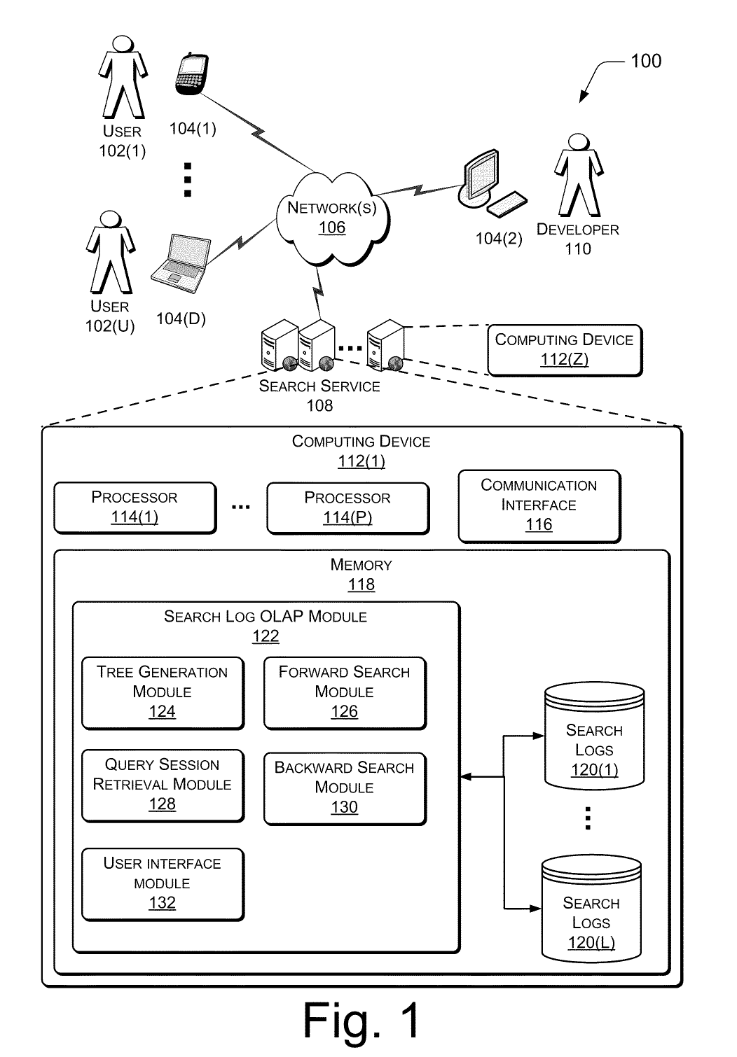

Illustrative Architecture FIG. 1 illustrates an example architecture 100 in which the claimed techniques for building, maintaining, and searching a search log index may be implemented. Users 102(1), . . . , 102(U) are shown using devices 104(1), . . . , 104(D). Letters within parentheses such as “(U)” or “(D)” denote any integer number greater than zero. The devices 104 may include, but are not limited to, computing devices such as a smartphone 104(1), desktop computer 104(2), servers, and other devices such as a laptop computer 104(D).

The devices 104(1)-(D) are coupled to a network 106 which in turn provides a connection to a search service 108. The network 106 may comprise a wired or wireless data network. The users 104(1)-(D) may submit queries to a search service 108, which may then process the queries and return results. A developer 110 may also use a device such as a desktop computer 104(2) to connect to the search service 108 via the network 106. Developer 110 may design, maintain, or otherwise facilitate the functioning of the search service 108.

The search service 108 may comprise one or more computing devices 112(1), . . . , 112(Z). The search service 108 may include a search engine which is configured to respond to queries from the user 102. In some implementations the computing devices 112(1)-(Z) may be servers or computing devices otherwise configured to perform the techniques described in this application. Each of the computing devices 112 includes one or more processors 114(1), . . . , 114(P), a communication interface 116, and a memory 118. In some implementations, the processor 114 may comprise multiple processors, or “cores.” The processors 114(1)-(P) are configured to execute programmatic instructions which may be stored in the memory 118.

The communication interface 116 provides a coupling to exchange data between other computing devices 112 in the search service 108, the devices 104(1)-(D) via the network 106, or both. For example, the communication interface 116 may include a HyperTransport interface, Ethernet interface, and so forth.

The computing device 112 may also include the memory 118. The memory 118 is configured to store instructions and data for use by the processor(s) 114. Memory may include any computer- or machine-readable storage media, including random access memory (RAM), non-volatile RAM (NVRAM), magnetic memory, optical memory, and so forth.

Stored within the memory 118 of at least one of the plurality of computing devices 112(1)-(Z) may be several modules configured to execute on the processor 114. The search logs 120(1), . . . , 120(L) may be distributed across the memory 118 of several of the computer devices 112(1)-(Z). Such distribution may be called for when the size of a search log and its associated indices is greater than the memory 118 capacity of a single computing device 112.

As mentioned above, the search logs 120 contain information resulting from logging user interactions with the search service 108. This may include interactions with a search engine therein, as well as the search log indices described herein. This information may provide useful information pertaining to needs and preferences of the users 102 accessing the search engine.

For example, the search engine of the search service 108 may provide a list of search results in response to a query from the user 102. This list may comprise links to a plurality of web pages. When the user 102 selects a link from within those search results, the action may be recorded in the search log 120 and considered a “vote” for that link and associated page.

The search logs 120 provide clues as to user preferences and desires. For example, search logs may reveal that searches for “Networked Computer Conference 2009” are often followed by searches for “Nearby Hotels.” By using the data provided in the search logs 120, the search service 108 may modify results to include search results for “Nearby Hotels” in response to the query for “Networked Computer Conference 2009.” This may help anticipate a commonly felt need of the users 102, and streamline their experience interacting with the search service 108.

The search logs 120 can grow in size enormously in relatively short periods of time such as days or hours, depending upon the activity of the search service 108. Analysis of these large search logs may outstrip available computing resources such as accessible memory or available processor cycles. To address this issue, a search log online analytic processing (OLAP) module 122 may be employed.

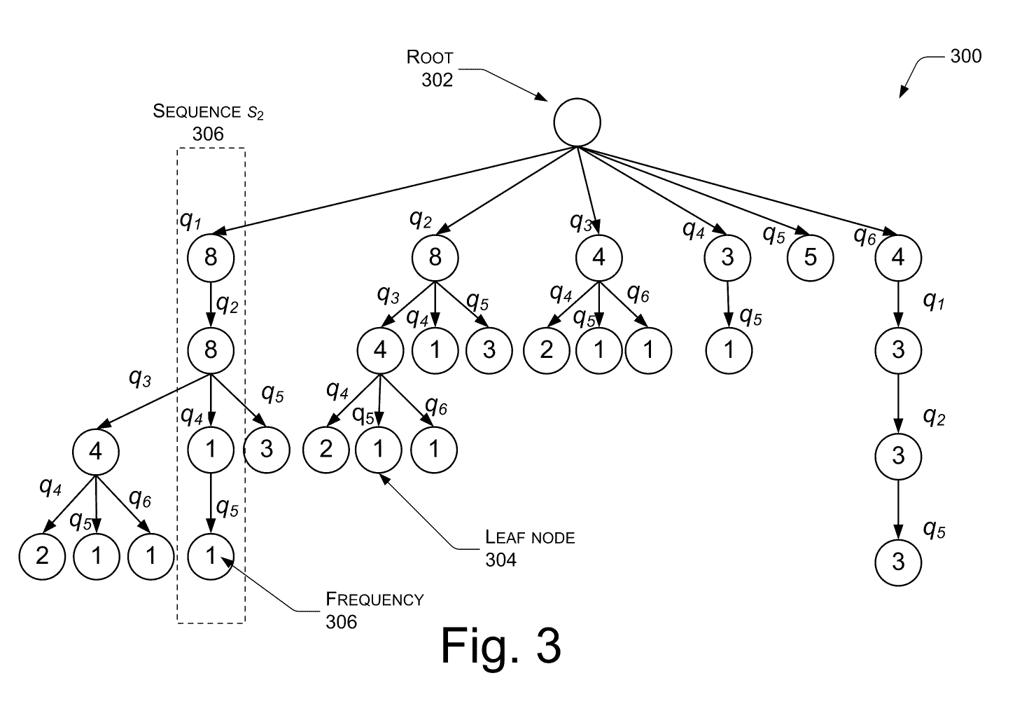

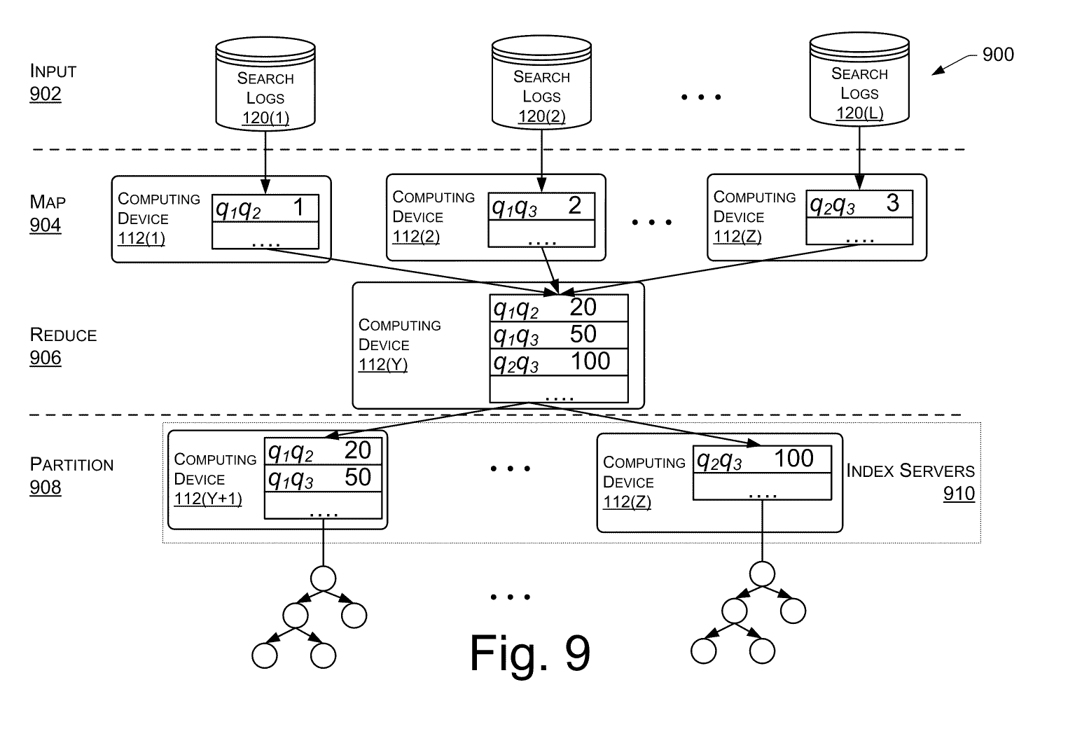

The search log OLAP module 122 may comprise several modules configured for various functions. A tree generation module 124 may be configured to distribute and build indices of search logs 120(1)-(L) across multiple computing devices 112. These indices may comprise suffix trees (including in some implementations enhanced suffix trees), reversed suffix trees, or both. These trees are configured to be suitable for querying with a forward search function, query session retrieval function, backward search function, and so forth. These functions are described in more detail below with regards to FIGS. 3-8. Generation of the trees is discussed in more detail below with regards to FIG. 9.

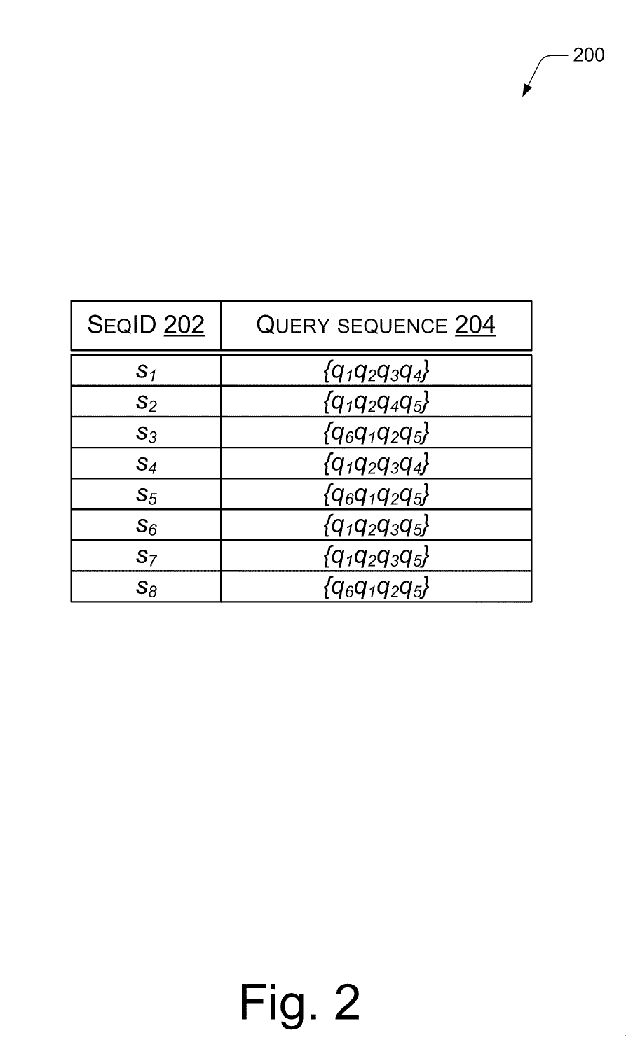

Tree generation module 124 may extract query sessions from search logs 120(1)-(L). This extraction includes extracting queries by a user from the search log as a stream, or series of queries. Next, each user's stream may be segmented into sessions based on a rule. For example, the rule may specify that two queries are split into two sessions when the time interval between them exceeds 30 minutes, or some other predetermined time threshold. These query sessions may then be used to build enhanced suffix trees and reverse suffix trees, as described below with regards to FIGS. 2-10.

A forward search module 126 is configured to execute a forward search against a suffix tree or enhanced suffix tree stored in memory 118. A forward search returns sequences from a session which are consecutive to a query sequence. Thus, the top-k most frequent sequences that have a specific prefix are returned. Forward searches may be used to provide query suggestions based on user inputs.

For example, the user 102 looking to buy a car may browse different brands of cars. Suppose the user 102 searches first for “Honda” then for “Ford” on search service 108. This results in a sequence s of queries where s={“Honda” “Ford”}. The search service 108 may use a forward search to find the top-k sequences s∘q, and suggest the queries q to the user. Such queries may be about some other brand such as “Toyota” or comparisons and reviews from a query about “car comparison.” Thus, the user 102 is presented with queries and their associated results which may be useful, as determined by the forward search module 126.

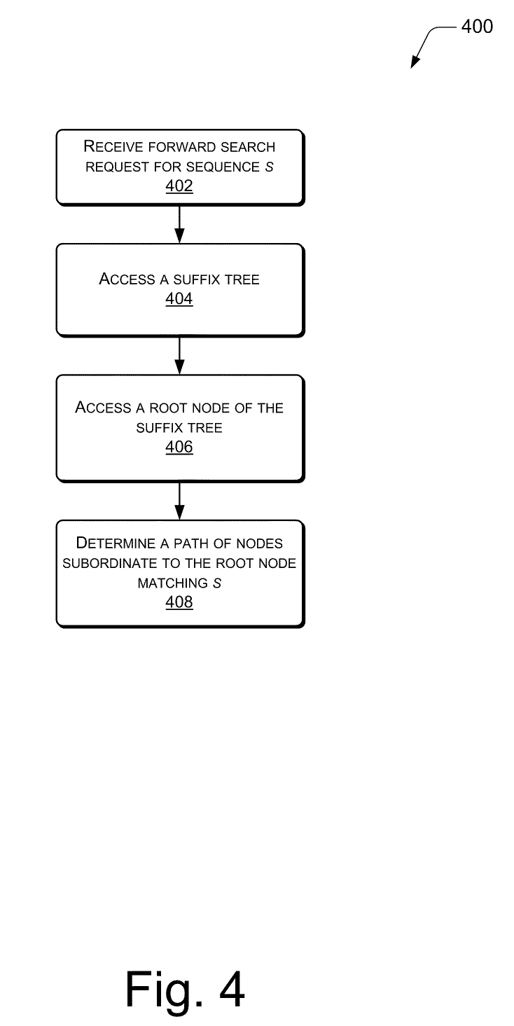

A suffix tree is described in more detail below with regards to FIG. 3. The process of forward searching implemented in forward search module 126 is described in more detail below with regards to FIG. 4.

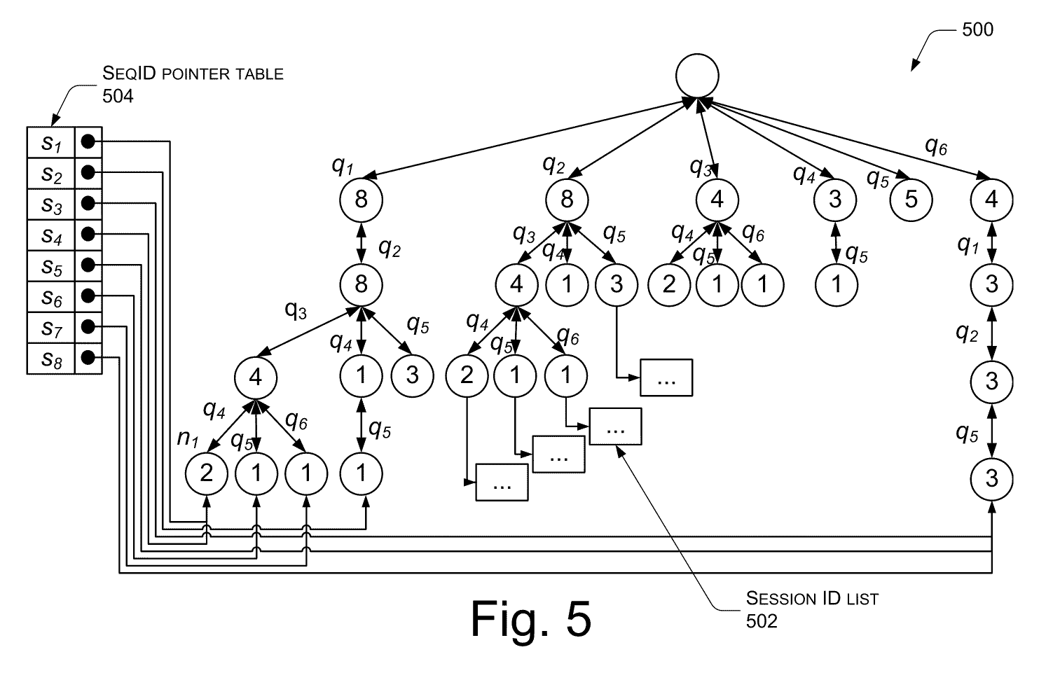

A query session retrieval module 128 is configured to execute a query session retrieval against an enhanced suffix tree stored in memory 118. The enhanced suffix tree is discussed below with regards to FIG. 5. A query session retrieval returns the top-k sessions which contain a specific sequence. Query session retrieval may be used to monitor search quality and diagnose causes of user dissatisfaction with queries.

For example, suppose a click-through-rate of a query for “Oprah” on search service 108 was high for the past two months, but has dropped dramatically in the last three days. To investigate the cause of the drop, developer 110 may perform a dissatisfactory query diagnosis (DSAT) using the query session retrieval module 128. This DSAT finds the top-k sessions containing “Oprah,” using the query session retrieval function of the query session retrieval module 128. Suppose that during the analysis the developer 110 discovers that sessions containing a query for “Oprah News Network” have high click-through rates, while more recent sessions in the past three days containing the query “book deal” have low click-through rates. The developer 110 may then determine that the reason for the decrease in the click-through rate may be that the search service 108 does not provide enough fresh results about the “Oprah News Network.” The developer 110 may then modify the search service 108 to respond with more results about the “Oprah News Network.”

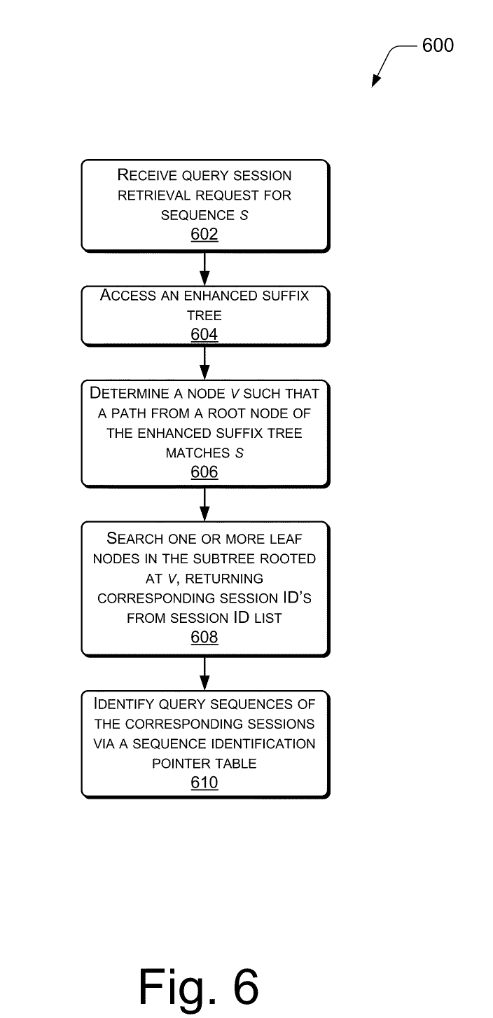

The query session retrieval may be executed against the enhanced suffix tree. The process of query session retrieval as implemented in the query session retrieval module 128 is described in more detail below with regards to FIG. 6.

A backward search module 130 is configured to execute a backward search against the reversed suffix tree stored in the memory 118. A backward search function determines the top-k most frequent sequences that have a specific suffix. Backward searches may be used in a keyword bidding scenario.

For example, a search service 108 may provide sponsored links in response to a search for a particular keyword. A merchant wishes to have a sponsored link to his store presented when the term “digital camcorder” is searched for at search service 108. Unfortunately, “digital camcorder” may be too expensive, already in use, or otherwise unavailable to the merchant. However, query subsequences which often appear immediately before the keyword “digital camcorder” may carry the same intent of a user. Suppose some users may query using terms such as “digital video recorder,” or “DC” in search sessions before they start (if ever) searching for the term “digital camcorder.” A backward search may be used to find these “digital video recorder” and “DC” sequences. Thus, the merchant may choose to sponsor “DC” as an acceptable and available alternative to “digital camcorder.”

Given the commonalities between the suffix tree and enhanced suffix tree, the enhanced suffix tree may also satisfy forward search functions. Thus, in some implementations the suffix tree may be omitted, resulting in the maintenance of the enhanced suffix tree as well as the reverse suffix tree.

Also shown in memory 118 is a user interface module 132. User interface module 132 may be configured to provide users 102 with the ability to execute forward search functions, backward search functions, and query session retrieval functions, among others. User interface module 132 may also be configured to provide developers 110 with an avenue to maintain, modify, or otherwise administer the search service 108.

FIG. 2 is a table depicting an example set of query sessions and their associated query sequences. Shown in this table are sequence identifiers (“SeqIDs”) 202 and query sequences (“s”) 204. Let Q be the set of unique queries in a search log 120. A query sequence s={q₁ . . . qₙ} is an ordered list of queries q where q₁ε Q (1≦i≦n). n is the length of s, denoted by |s|=n. A subsequence of sequence s={q₁ . . . qₙ} is a sequence s′={q₁₊₁ . . . q₁₊ₘ} where m is the length of s′, m≧1, i≧0, and i+m≦n, denoted by s′ [symbol] s. In particular, s′ is a prefix of s if i=0. s′ is a suffix of s if i=n−m. The concatenation of two sequences s₁={q₁ . . . qₙ₁} and s₂={q′₁ . . . q′ₙ₂} is s₁∘s₂={q₁ . . . qₙ₁q′ₙ₂}.

For example, SeqID 202 as shown in FIG. 2 includes sequence s₂=q₁q₂q₄q₅). Within query sequence 204 s₂, first query q₁ was executed, followed second by execution of q₂, followed third by execution of q₄, and finally execution of q₅.

FIG. 3 illustrates a suffix tree 300 based on the table of FIG. 2. Suffix trees provide a data structure to organize suffixes of a given sequence into a prefix sharing tree such that each suffix corresponds to a path from the root node 302 to a leaf node 304 in the tree. Organizing the suffixes of s into a tree structure allows determination of when a sequence s′ is a subsequence of s by examining the suffix tree. Sequence s′ is a subsequence of s when there is a path corresponding to s′ from the root of the suffix tree.

Within suffix tree 300, each edge is labeled by a query and each node (except for the root 302) corresponds to the query sequence constituted by the labels along the path from the root to that node. For example, query sequence s₂ is shown at 306 within dotted lines.

Search service 108 may use frequency of occurrence in analysis. Given a set of query sessions D={s₁, s₂, . . . s_{N}}, the frequency of a query sequence s is sfreq(s)=|{sᵢ|s=sᵢ}|. Each query in s may be considered as a dimension, while the frequency of s may be considered a measure along that dimension. Within the trees depicted in FIGS. 3-5 the frequency of a query sequence may be depicted within the leaf node, as shown at 306. Thus, continuing the example from above, the frequency of occurrence of sequence s₂ in the search log is 1.

FIGS. 4, 6, 8, 10 and 12 illustrate processes that may, but need not, be implemented using the architecture shown in FIG. 1. The processes 400, 600, 800, 1000, and 1200 are illustrated as collections of blocks in logical flow diagrams, which represent a sequence of functions that can be implemented in hardware, software, or a combination thereof. In the context of software, the blocks represent computer-executable instructions that, when executed by one or more processors, perform the recited functions. Generally, computer-executable instructions include routines, programs, objects, components, data structures, and the like that perform particular functions or implement particular abstract data types. The order in which the functions are described is not intended to be construed as a limitation, and any number of the described blocks can be combined in any order and/or in parallel to implement the process. For discussion purposes, the process will be described in the context of the architecture of FIG. 1, but may be implemented by other architectures.

FIG. 4 is a flow diagram of an example process 400 of a forward search function executed against the suffix tree of FIG. 3. At block 402 the forward search module 126 receives a forward search request for a sequence s. For example, suppose the query sequence is s={q₁q₂}. At block 404, the forward search module 126 accesses a suffix tree, such as that shown in FIG. 3 or an enhanced suffix tree as shown below in FIG. 5. At block 406, the forward search module 126 accesses a root node of the suffix tree to begin the search.

At block 408, the forward search module 126 determines the path of nodes subordinate to the root node which matches sequence s. This determination may result in a candidate answer set Cand. Cand may be maintained as a priority queue in, for example, frequency descending order. Therefore, Cand={q₃, q₅, q₄} initially. Should a user be interested in the top-two answers, the head element q₃ from Cand may be selected. As Cand is maintained as a priority queue, q₃ has the largest frequency and can be placed into a final answer set R. This occurs as a result of a useful attribute of a suffix tree: a descendant node may not have a frequency higher than that in any of its ancestor nodes.

Sequences corresponding to the child node may be inserted in Cand. The priority queue now becomes Cand={q₅, q₃q₄, q₄, q₃q₅, q₃q₆}. As before, the head element, now q₅, is selected and placed in R. Therefore, the top-two answers are R={q₃, q₅}. Should the user be interested in the top-three answers, the queue may be updated to Cand={q₃ q₄, q₄, q₃q₅, q₃q₆} since q₅ does not have a child. Thus, the top-three answers are R={q₃, q₅, q₃q₄}.

As described herein, a suffix tree or enhanced suffix tree may be distributed across multiple computing devices 112(1)-(Z). When distributed across multiple computing devices 112(1)-(Z), each computing device 112 may store the local subtree stored in memory 118 and return the local top-k results to one or more coordinating computing devices 112. Because the local subtrees are exclusive in this example, the global top-k results are among the local top-k results. Thus, the one or more coordinating computing devices 112 may examine the local top-k results and select the most frequent results as the global top-k results. In some implementations, the local subtree may include a local enhanced suffix tree and a local reversed suffix tree. In other implementations, the local enhanced suffix tree and the local reversed suffix tree may be distributed across a plurality of computing devices 112.

FIG. 5 illustrates an enhanced suffix tree 500 based on the table of FIG. 2. Enhancing the suffix tree of FIG. 3 allows the query session retrieval module 128 to service query session retrieval functions. As described above, the query session comprises a set of query sequences.

In the enhanced suffix tree 500, query session information in the form of a session identification list (“SIDL”) 502 has been added to the suffix tree described in FIG. 3. This SIDL 502 may be computed as a byproduct of the suffix tree construction, thus its generation is computationally efficient. The SIDL 502 provides information about those sessions which contain the associated suffix. In some implementations, the SID 502 may be sorted in frequency descending order. This sorting further increases the speed of response when querying.

To minimize duplication of data and reduce otherwise duplicative storage of the query sequences, the query sequences stored in the enhanced suffix tree 500 may be re-used by including a sequence identifier (SeqID) pointer table 504. The SeqID pointer table 504 provides a mapping between sequences and corresponding leaf nodes in the enhanced suffix tree 500. Continuing the example from above, entry s₂ in the SeqID pointer table 504 maps query sequence s₂ to the appropriate leaf node.

FIG. 6 is a flow diagram of an example process 600 of a query session retrieval function executed against the enhanced suffix tree of FIG. 5. At block 602, the query session retrieval module 128 receives a query session retrieval request for a sequence s. At block 604, the query session retrieval module 128 accesses the enhanced suffix tree. At block 606, the query session retrieval module 128 determines the node ν such that a path from a root node of the enhanced suffix tree matches s. At block 608, the query session retrieval module 128 searches one or more of the leaf nodes in the subtree rooted at ν and identifies one or more corresponding session IDs of the top-k frequent sessions stored in the session ID list 502.

At block 610, the query session retrieval module 128 identifies the query sequences of the corresponding sessions via a SeqID pointer table 504. For example, the entry for sequence s₁ in the SeqID pointer table 504 points to leaf node n₁. To find the sequence of s₁, a path is traced from the leaf node n₁ back to the root, followed by reversing the order of the labels on the path. Thus, in this example, the path from n₁ to the root is {q₄q₃q₂q₂} and thus s1={q₁q₂q₃q₄}.

In some implementations, the tree may be modified to further improve search performance. Each internal node ν in the suffix tree may store a list of k₀ sessions that are most frequent in the subtree of ν, where k₀ is a number so that most of the session retrieval requests ask for less than k₀ results. The value of k₀ may be static, or dynamically set. In one implementation, k₀ may be approximately 10.

Once this list is stored, session retrievals requesting less than k₀ results are able to obtain the top k-sessions directly from the node which is the root of the subtree ν, and thus rendering a search of the leaf nodes in the subtree unnecessary. When a session retrieval requests more than k₀ results, the subtree may be searched as previously described.

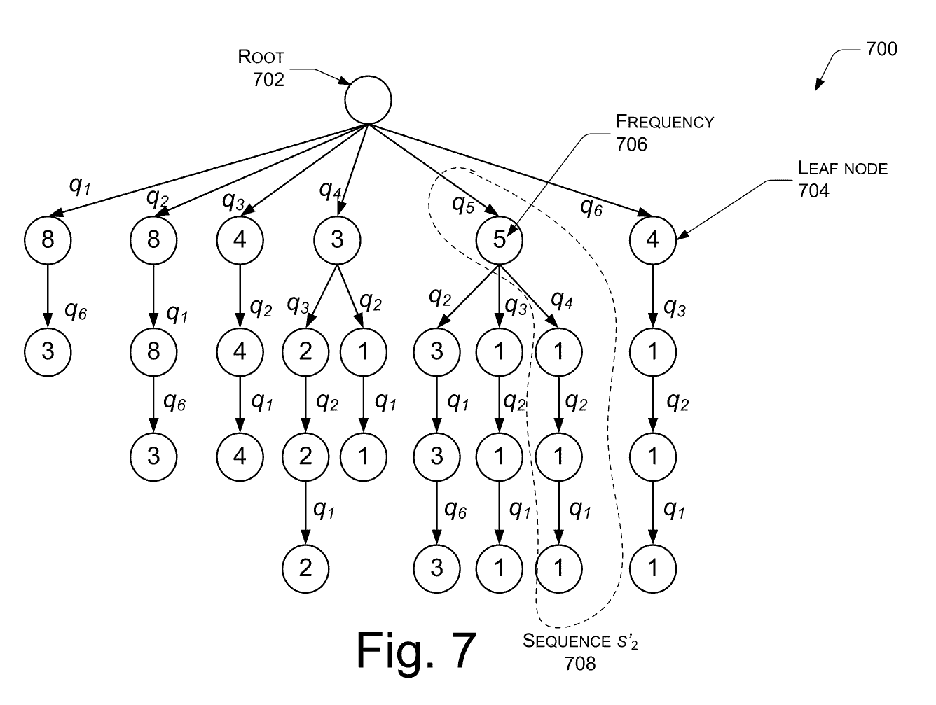

FIG. 7 illustrates a reversed suffix tree based on the table of FIG. 2. While a forward search function and a query session retrieval function may be serviced with an enhanced suffix tree as described in FIG. 4, backward searches are more efficiently handled with a reversed suffix tree. Similar to the trees of FIGS. 3 and 5, a root node 702 is shown, with subordinate leaf nodes 704. A frequency of occurrence of a sequence s is also shown at 706.

For each query sequence s=q₁ . . . qₙ) a reversed query sequence s′={qₙqₙ₋₁ . . . q₁} may be obtained. The suffixes s′ may then be inserted into a reversed suffix tree as shown. Continuing the example from above, recall s₂={q₁q₂q₄q₅}. Thus, the reversed suffix s₂′={q₅q₄q₁q₁} is shown by dotted line at 708.

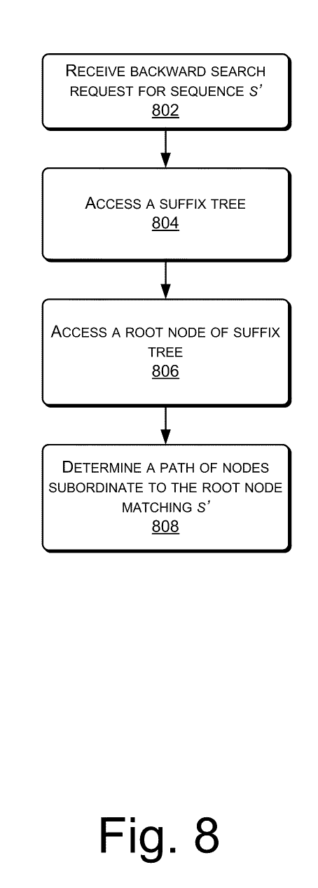

FIG. 8 is a flow diagram of an example process 800 of a backward search function executed against the reversed suffix tree of FIG. 7. At block 802, the backward search module 130 receives a backward search request for a sequence s′. At block 804, the backward search module 130 accesses a reversed suffix tree. At block 806, the backward search module 130 accesses a root node of the reversed suffix tree to begin the search. At block 808, the backward search module 130 determines a path of nodes subordinate to the root node which matches sequence s′. Generally, the process of backward search may be considered similar to that of forward search function described above with respect to FIG. 4 due to their similar traversal of the suffix tree.

FIG. 9 illustrates the construction 900 of a distributed index comprising suffix trees. These suffix trees are suitable for use by the forward search, backward search, and query session retrieval functions of search log OLAP module 122. As shown at 902, input in the form of search logs 120(1)-(L) may be received. Search logs 120 may be generated by search service 108 or received from an external search engine.

Given the large size of the search logs, they may be broken down for distributed processing using a method such as MapReduce. MapReduce provides a framework for distributed processing on large data sets across clusters of computers. At 904, search logs 120(1)-(L) are broken down by computing devices 112(1)-(Z) in a “map” phase for distributed processing. At this “map” phase, each computing device 112 processes a subset of query sessions. For each query session s, the computing device emits an intermediate key-value pair (s′, 1) for every suffix of s′ of s, where the value 1 here is the contribution to frequency of suffix s′ from s. Thus, as shown in this example, computing device 112(1) has determined that sequence q₁q₂ has a frequency of 1.

At 906, a “reduce” phase consolidates the results from the “map” phase. Intermediate key-value pairs having suffix s′ as the key are processed on the same computing device 112(Y). The computing device 112(Y) then emits a final pair (s′, freq(s′)), where freq(s′) comprises the number of intermediate pairs carrying key s′.

The combination of map 904 and reduce 906 returns suffixes of sessions and their frequencies. Ideally these suffixes of sessions and their frequencies would be consolidated into a single tree. However, given the nature of data present in the search logs 120(1)-(L), the number of suffixes is typically very large. Thus, an entire suffix tree would be unable to fit within the available memory 118 of the computing device 112.

At 908, the suffix tree is partitioned into subtrees. Each subtree is sized to fit within the memory 118 available on the computing devices 112(1)-(L) which have been tasked as index servers 910. Subtrees may be configured to be exclusive from each other, thus there are no identical paths present between two subtrees. Additionally, subtrees may be distributed such that their sizes will not vary significantly in order to distribute workload across the index servers 910.

Partitioning subtrees to fit within the memory 118 available calls for an estimation of how much memory a subtree may consume. Because suffixes may share common prefixes, estimation of the size of a subtree using only the suffixes requires special consideration. For example, a subtree comprising two suffixes s₁={q₁q₂q₃} and s₂={q₁q₂q₄} has only 4 nodes since the two suffixes share a prefix of {q₁q₂}.

Given a set of suffix sequences, an upper bound of the size of the suffix tree constructed from the suffix sequences is the total number of query instances in the suffix sequences. For example, the upper bound of the size of the suffix tree constructed from s₁={q₁q₂q₃} and s₂={q₁q₂q₄} is 6. Using this upper bound in space allocation is conservative. Furthermore, this conservative space allocation reserves sufficient space for growth of the tree as new search logs are added.

To partition the suffix tree, for each query q ε Q, a MapReduce or other distributee computing approach may be applied to compute the upper bound of a subtree rooted at q. In the “map” phase, each suffix sequence s generates an intermediate key-value pair (q₁, |s|−1), where q₁ is the first query in s, and |s|−1 is the number of queries in s other than q₁. In the “reduce” phase, all intermediate key-value pairs carrying the same key, such as q₁, are processed by the same computer device 112. The computing device in turn outputs a final pair (q₁, size) where size is the sum of values in all intermediate key-value pairs with key q₁. Thus, size is the upper bound of the size of the subtree rooted at query q₁. If size is less than the amount of memory available on an index server 910, the whole subtree rooted at q₁ may be held in the index server. When this is the case, all of the suffixes whose first query is q₁ may be assigned to the same index server 910. When size is less than the amount of memory available on an index server 910, the subtree may be further divided recursively and assign the suffixes accordingly. Thus, it is possible to guarantee that the local suffix trees (including enhanced suffix trees and local reversed suffix trees) on different index servers are exclusive of one another.

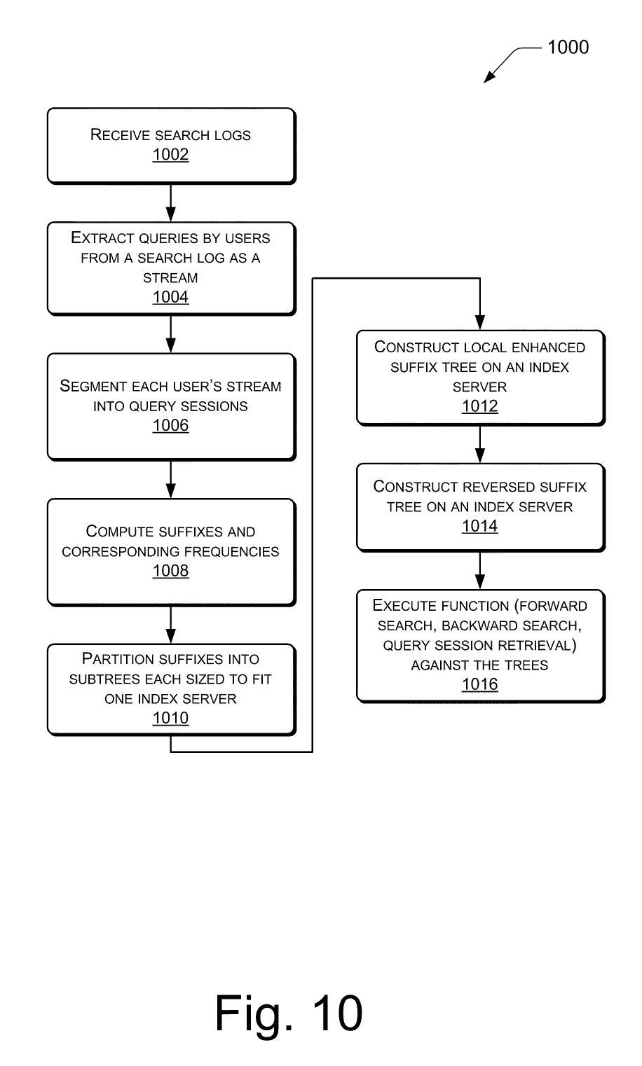

FIG. 10 is a flow diagram of an example process 1000 of building distributed index trees. At block 1002, the tree generation module 124 receives the search logs 120(1)-(L). At block 1004, tree generation module 124 extracts queries by users from a search log as a stream. At block 1006, tree generation module 124 segments each user's stream into query sessions. This segmentation may be done in accordance with a rule such as elapsed time between queries. For example, two queries may be split into two sessions when the time elapsed interval between them exceeds about 30 minutes.

At block 1008, tree generation module 124 may compute the suffixes and corresponding frequencies via a distributed computing model. In some implementations, this distributed computing model may comprise a MapReduce methodology.

At block 1010, tree generation module 124 partitions suffixes into subtrees, such that each subtree is sized to fit memory available in one index server. As described above, this estimate may be conservative to allow for future growth of the subtree.

At block 1012, tree generation module 124 constructs a local enhanced suffix tree on an index server. As described above, the enhanced suffix tree may be used to respond to forward searches as well as query session retrievals.

At block 1014, tree generation module 124 constructs a reversed suffix tree on an index server. In some implementations, this may be on a same index server storing a local enhanced suffix tree. As described above, the reversed suffix tree may be used to respond to backward searches.

At block 1016, tree generation module 124 may then execute of a function such as a forward search function, backward search function, or query sessions retrieval function against the constructed trees. This may be in response to a request from the user 102, the developer 110, or an internal process of the search service 108.

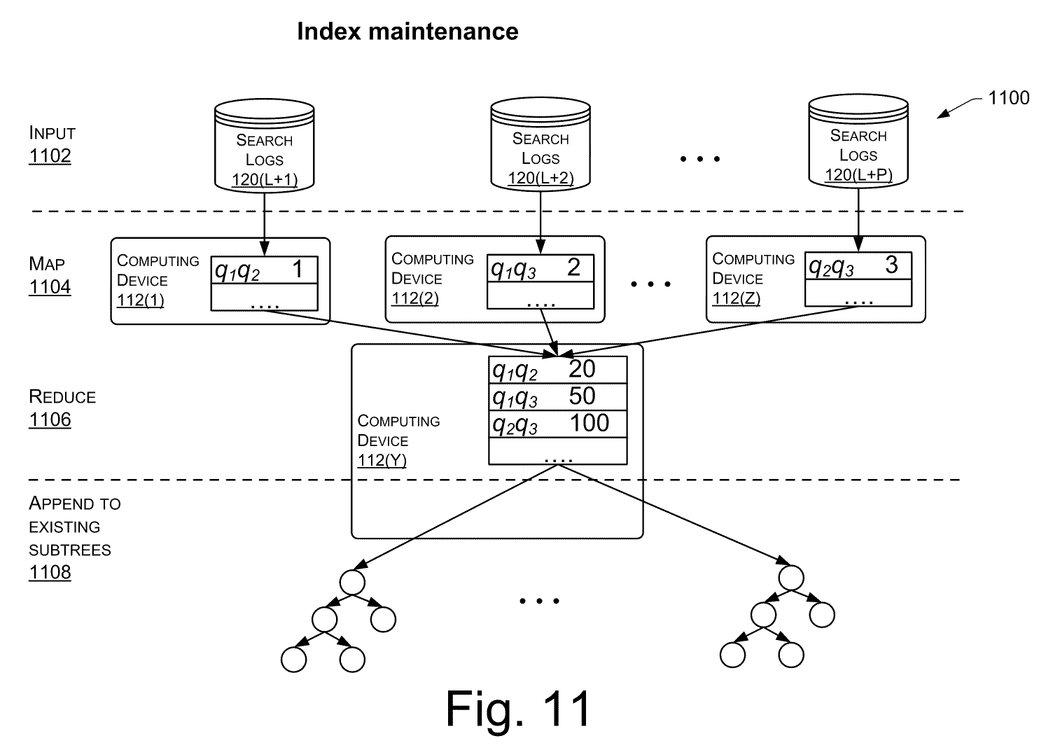

FIG. 11 illustrates the maintenance 1100 of the distributed index of FIG. 9. As mentioned earlier, search logs 120 may continue to be generated while search service 108 is in operation as additional searches are run by users 102. At 1102, the incremental search logs 120(L+1), . . . , (L+P) may be received. Similar to FIG. 9 above, the search logs 120(L+1)−(L+P) may be processed using a “map” 1104 and “reduce” 1106 process to determine new suffixes and their associated frequencies.

These new suffixes and frequencies may then be appended to existing subtrees, so long as the size of the overall subtree does not exceed the memory available on the index server. When the overall subtree would exceed the memory available on the index server, a recursive partitioning of the subtree may take place. This partitioning may occur as described above with respect to 908.

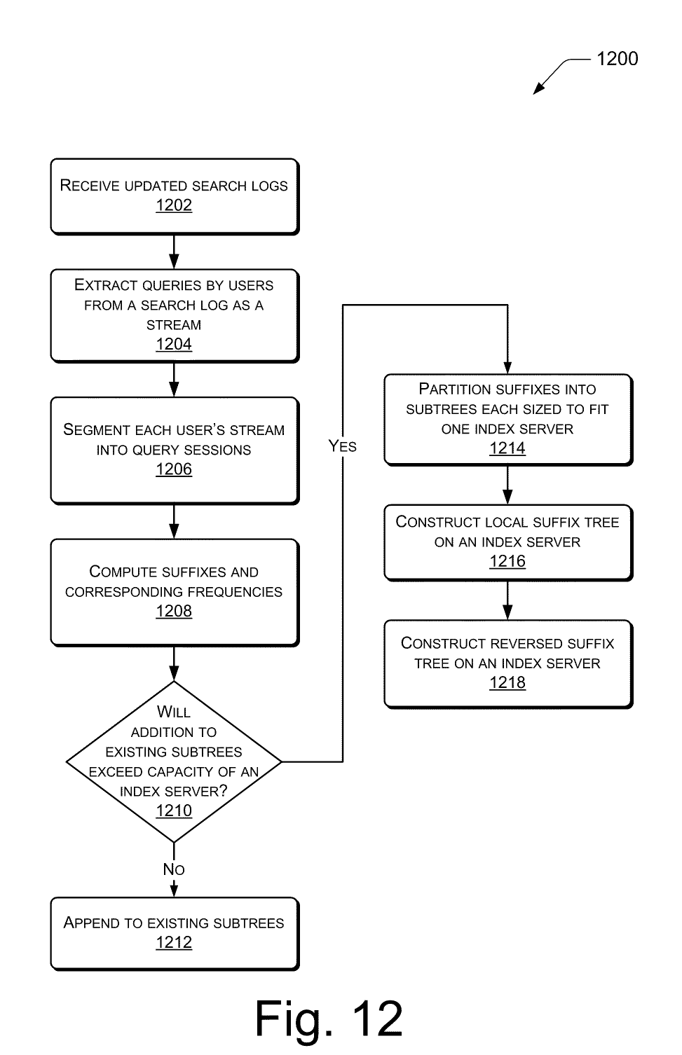

FIG. 12 is a flow diagram of an example process 1200 of maintaining the distributed index trees. At block 1202, the tree generation module 124 receives the updated search logs. At block 1204, the tree generation module 124 extracts queries by the user from the search log as a stream. At block 1206, tree generation module 124 segments each user's stream into query sessions. As described above with regards to 1006, this segmentation may be done in accordance with a rule such as elapsed time between queries.

At block 1208, the tree generation module 124 computes suffixes and corresponding frequencies via a distributed computing model. In some implementations, this distributed computing model may comprise a MapReduce methodology.

At block 1210, the tree generation module 124 determines whether addition of the newly computed suffixes and corresponding frequencies to existing subtrees would exceed the memory 118 capacity of one or more index servers. When sufficient memory 118 capacity is available, at block 1212, the tree generation module 124 may append the newly computed suffixes and corresponding frequencies to the existing subtrees.

When block 1210 determines that addition of the newly computed suffixes and corresponding frequencies to the subtrees would cause those subtrees to exceed the memory 118 capacity of one or more index servers, block 1214 is called upon. At block 1214, the tree generation module 124 combines the newly computes suffixes and corresponding frequencies to the existing subtrees and partitions the resulting tree such that each subtree will now fit within the memory 118 of an index server.

At block 1216, the tree generation module 124 then constructs a new local enhanced suffix tree on an index server, as described above with respect to 1012. At block 1218, the tree generation module 124 constructs a new reversed suffix tree on an index server, as described above with respect to 1016.

### CONCLUSION

Although specific details of illustrative methods are described with regard to the figures and other flow diagrams presented herein, it should be understood that certain acts shown in the figures need not be performed in the order described, and may be modified, and/or may be omitted entirely, depending on the circumstances. As described in this application, modules and engines may be implemented using software, hardware, firmware, or a combination of these. Moreover, the acts and methods described may be implemented by a computer, processor or other computing device based on instructions stored on memory, the memory comprising one or more computer-readable storage media (CRSM).

The CRSM may be any available physical media accessible by a computing device to implement the instructions stored thereon. CRSM may include, but is not limited to, random access memory (RAM), read-only memory (ROM), electrically erasable programmable read-only memory (EEPROM), flash memory or other solid-state memory technology, compact disk read-only memory (CD-ROM), digital versatile disks (DVD) or other optical disk storage, magnetic cassettes, magnetic tape, magnetic disk storage or other magnetic storage devices, or any other medium which can be used to store the desired information and which can be accessed by a computing device.

What is claimed is:

1. One or more computer-readable storage media storing instructions that, when executed by a processor, cause the processor to perform acts comprising:
receiving a search log generated by a search engine;
extracting query sessions from the search log;
computing from the query sessions suffixes and corresponding frequencies of the suffixes;
partitioning a tree of the computed suffixes and corresponding frequencies into a plurality of subtrees with each subtree configured to fit within an available computer-readable storage media of an individual computing device;
constructing an enhanced suffix tree from the subtree; and
constructing a reversed suffix tree from the subtree.

2. The computer-readable storage media of claim 1, wherein the enhanced suffix tree comprises a suffix tree having:
a session identification list associated with a leaf node and specifying sessions containing the suffix of the leaf node; and
a sequence identification pointer table associated with one or more of the leaf nodes and specifying search sequences.

3. The computer-readable storage media of claim 1, further comprising:
executing a forward search function, query session retrieval function, or both against the enhanced suffix tree.

4. The computer-readable storage media of claim 3, the forward search function comprising:
determining a path of nodes subordinate to a root node matching a sequence s in the enhanced suffix tree.

5. The computer-readable storage media of claim 3, the query session retrieval search function comprising:
determining a node ν such that a path from a root node of the enhanced suffix tree matches a sequence s;
searching one or more leaf nodes in a subtree rooted at ν to identify one or more corresponding session IDs of the top-k frequent sessions stored in a session ID list; and
identifying the query sequences of the corresponding sessions via a sequence ID pointer table.

6. The computer-readable storage media of claim 3, the backward search function comprising:
determining a path of nodes subordinate to a root node matching a sequence s′ in the reverse suffix tree.

7. The computer-readable storage media of claim 1, further comprising:
executing a backward search function against the reversed suffix tree.

8. A method comprising:
accessing an index comprising one or more distributed suffix trees derived from one or more search engine search logs;
receiving a query directed to the index; and
searching the index in response to the received query.

9. The method claim 8, further comprising:
executing a forward search function, a backward search function, or query session retrieval function against an enhanced suffix tree, a reversed suffix tree, or both.

10. The method claim 9, the forward search function comprising:
determining a path of nodes subordinate to a root node matching a sequence s in an enhanced suffix tree.

11. The method claim 9, the query session retrieval search function comprising:
determining a node ν such that a path from a root node of an enhanced suffix tree matches a sequence s;
searching one or more leaf nodes in a subtree rooted at ν to identify one or more corresponding session IDs of the top-k frequent sessions stored in a session ID list; and
identifying the query sequences of the corresponding sessions via a sequence ID pointer table.

12. The method claim 9, the backward search function comprising:
determining a path of nodes subordinate to a root node matching a sequence s′ in a reverse suffix tree.

13. The method of claim 8, further comprising generating the index, the generating comprising:
extracting one or more query sessions from the one or more search engine search logs;
computing, from the one or more query sessions, suffixes and corresponding frequencies of the suffixes;
partitioning a tree of the computed suffixes and corresponding frequencies into a plurality of subtrees wherein each subtree is configured to fit within an available computer-readable storage media of a computing device;
constructing a local enhanced suffix tree on each computing device from the subtree; and
constructing a reversed suffix tree on each computing device from the subtree.

14. The method of claim 13, the extracting comprising:
extracting queries made by users from the search log as a stream; and
segmenting each user's stream into a query session.

15. The method of claim 8, further comprising maintaining the index, the maintaining comprising:
receiving one or more search engine logs;
extracting one or more query sessions from the one or more search engine search logs;
computing, from the query sessions, suffixes and corresponding frequencies of the suffixes; and
determining when adding the computed suffixes and corresponding frequencies will exceed a memory capacity of a given index server;
when adding the computed suffixes and corresponding frequencies will not exceed a memory capacity of a given index server, appending the computed suffixes and corresponding frequencies to one or more preexisting subtrees;
when adding the computed suffixes and corresponding frequencies will exceed a memory capacity of a given index server:
partitioning a tree comprising preexisting subtrees and the computed suffixes and corresponding frequencies into a plurality of subtrees wherein each subtree is configured to fit within an available computer-readable storage media of a computing device;
constructing a local enhanced suffix tree on each computing device from the subtree; and
constructing a reversed suffix tree on each computing device from the subtree.

16. The method of claim 15, the extracting comprising:
extracting queries made by users from the search log as a stream; and
segmenting each user's stream into a query session.

17. A system comprising:
one or more computing devices, wherein each computing device comprises one or more processors and a memory coupled to the one or more processors;
an enhanced suffix tree data structure distributed across at least a portion of the plurality of computing devices and representing an index of a search engine search log;
a reversed suffix tree data structure distributed across at least a portion of the plurality of computing devices and representing the index of a search engine search log;
a search log online analytic processing module stored in the memory of one or more of the computing devices and containing instructions, that when executed by the one or more processors of the one or more computing devices:
performs a forward search, backward search, a query session retrieval, or a combination thereof against the enhanced suffix tree data structure, reversed suffix tree data structure, or both.

18. The system of claim 17, further comprising a tree generation module stored in the memory of one or more of the computing devices and configured to:
extract one or more query sessions from one or more search engine search logs;
compute, from the query sessions, suffixes and corresponding frequencies of the suffixes;
partition a tree of the computed suffixes and corresponding frequencies into a plurality of subtrees wherein each subtree is configured to fit within an available computer-readable storage media of a computing device;
construct the portion of the enhanced suffix tree from the subtree; and
construct the portion of the reversed suffix tree on each computing device from the subtree.

19. The system of claim 17, wherein the enhanced suffix tree data structure comprises a suffix tree data structure having a session identification list associated with one or more leaf nodes of the enhanced suffix tree.

20. The system of claim 17, wherein the enhanced suffix tree data structure comprises a sequence identification pointer table associated with one or more leaf nodes of the enhanced suffix tree.
